(19) United States
(12) Patent Application Publication
(10) Pub. No.: US 2011/0236116 A1
(43) Pub. Date: Sep. 29, 2011

(54) ROLL PAPER PRINTER

(75) Inventor: Nobuhiro INOUE, Matsumoto-shi (JP)

(73) Assignee: SEIKO EPSON CORPORATION, Tokyo (JP)

(21) Appl. No.: 13/045,570

(22) Filed: Mar. 11, 2011

(30) Foreign Application Priority Data
Mar. 29, 2010 (JP) 2010-075003

(51) Int. Cl. B41J 11/04

(52) U.S. Cl. 400/618

(57) ABSTRACT

A paper roll printer has a paper roll compartment that stores paper roll so that it can roll with the axis of rotation transverse, and a side pressure plate inclined so that it touches part of the side of the paper roll and approaches the side with decreasing proximity to a supply roller. The paper roll transportation position of the supply roller that supplies paper from the paper roll is disposed to vertically overlap a paper roll of the maximum diameter that can be stored in the paper roll compartment. A movement limiting member that restricts movement of the paper roll horizontally and upwardly in the paper roll compartment is disposed opposite the supply roller.

### RELATED APPLICATION (S)

The instant application claims the benefit of Japanese patent application No. 2010-075003 filed Mar. 29, 2010 the entire disclosure of which is incorporated by reference herein.

### BACKGROUND

1. Technical Field

The present disclosure relates to a printer, e.g., a paper roll printer that unrolls and prints on paper supplied from a paper roll.

2. Related Art

Receipt printers and other types of paper roll printers that print on paper supplied from a paper roll are commonly used in POS (point-of-sale) systems, for example.

Japanese Unexamined Patent Appl. Pub. JP-A-2009-78414, for example, describes a printer that has a paper roll storage mechanism for storing a paper roll, and feeds recording paper pulled from the paper roll stored in this paper roll storage mechanism by means of a platen roller for printing with a thermal head.

Japanese Unexamined Patent Appl. Pub. JP-A-2009-269399 describes a printer that threads a recording paper web around a tension guide that is positioned between the paper supply position of a supply roller and the paper feed position of a paper feed roller, applies specific tension to the paper by means of the tension guide, and conveys the recording paper forward or reverse by means of the paper feed roller through the transportation path from the paper supply position to the paper feed position. This printer detects if the tension on the recording paper exceeds a predetermined allowable maximum, and if this maximum tension is exceeded when feeding the recording paper forward, starts the recording paper supply operation of the supply roller after a specific delay from the time it is detected that the maximum tension is exceeded.

The inventors have recognized that, at an increased printing speed, the paper roll can bounce up and down inside the storage compartment particularly when a large amount of paper is fed during a printing process, for example, and, as a result, keeping constant tension on the recording paper supplied from the paper roll may be difficult.

One way to stabilize the tension in this situation is to increase the stroke of the tension guide that applies tension to the recording paper, but increasing the stroke tends to increase the printer size.

### SUMMARY

In some embodiments, a paper roll printer includes a paper roll compartment for storing therein a paper roll with a transverse axis of rotation, and a supply roller for supplying a web of paper from the paper roll stored in the paper roll compartment. Inclined side pressure plates are provided for touching side ends of the paper roll and become closer to the side ends with decreasing proximity to the supply roller. A platen unit includes transportation rollers that are disposed downstream of the supply roller in a transportation path and above the paper roll compartment for holding and conveying the web of paper along the transportation path. A tension roller is moveably supported on the platen unit at a position on the transportation path between the supply roller and the transportation rollers to maintain constant paper tension on the transportation rollers. A movement limiting member is disposed to the paper roll compartment at a position opposite the supply roller for limiting movements of the paper roll horizontally and upwardly in the paper roll compartment. A paper transportation position of the supply roller is disposed on a vertical line through a paper roll of the maximum diameter storable in the paper roll compartment.

In some embodiments, a paper roll printer includes a printhead, a platen unit having a platen opposite the printhead, a paper roll compartment for storing a paper roll, and a supply roller for supplying a paper web from the paper roll stored in the paper roll compartment. A transportation roller for conveying the paper web is disposed downstream of the supply roller in a transportation path and upstream of the printhead in the transportation path. A tension roller is provided for contacting the paper web being conveyed between the supply roller and the transportation roller. The paper roll compartment includes a bottom on which the paper roll is positionable, a first side plate for facing and contacting one of opposite side ends of the paper roll positioned on the bottom, a second side plate for facing and contacting the other side end of the paper roll positioned on the bottom, and a movement limiting member for limiting movements of the paper roll horizontally and upwardly and positioned opposite the supply roller. The first side plate and the second side plate are disposed so that the gap between the first side plate and second side plate across the width of the paper roll narrows in the direction in which the paper web is pulled from the paper roll. The supply roller is disposed so that, when a paper roll of the maximum storable diameter is stored in the paper roll compartment, the contact point of the supply roller with the paper web vertically overlaps the paper roll of the maximum diameter. The platen unit is positioned above the paper roll compartment and includes the transportation roller and the tension roller. The tension roller is supported movably horizontally on the platen unit and is urged in a direction away from the printhead.

In some embodiments, a printer includes a compartment for storing therein a roll of a printing medium with a transverse axis of rotation, a supply roller for pulling a web of the printing medium from the roll stored in the compartment, and side pressure plates for facing and touching opposite side ends of the roll, respectively. The side pressure plates converge toward each other so that the gap between the side pressure plates narrows in the direction in which the printing medium is pulled from the roll.

### BRIEF DESCRIPTION OF THE DRAWINGS

FIG. 1 is a perspective view of a paper roll printer according to one or more embodiments of the invention.

FIG. 2 is a side view of the printer with the printer case removed.

FIG. 3 is a schematic side view of a transportation mechanism.

FIG. 4 is a side view similar to FIG. 2, showing a paper web supplied from a paper roll and wrapped around a tension roller.

FIG. 5 is a side view similar to FIG. 4, showing the tension roller at a different position.

FIG. 6 is a perspective view of a paper roll compartment.

FIG. 7 is a schematic front view of the paper roll compartment.

FIGS. 8-11 are side views similar to FIG. 4, showing the paper roll supply operation.

FIG. 12 is a force diagram schematically describes forces associated with the tension roller.

FIG. 13 is a graph of the relationship between the tension roller contact angle and a coefficient.

### DESCRIPTION OF EXEMPLARY EMBODIMENTS

Exemplary embodiments of a paper roll printer according to the invention is described below with reference to the accompanying figures.

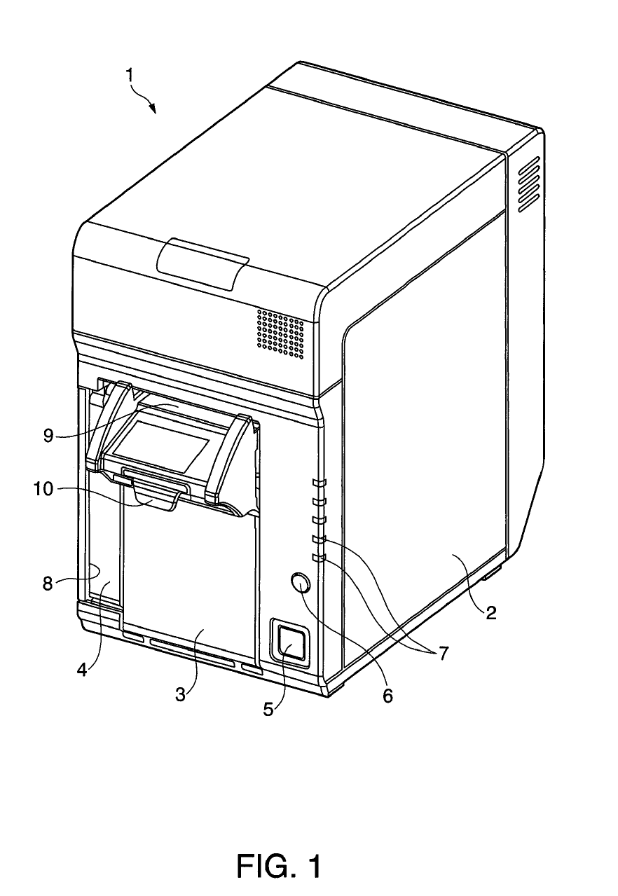

A inkjet printer 1 shown in FIG. 1 is a paper roll printer that uses plural colors of ink to print in color on a part of a paper web delivered from a paper roll 11, and has a paper roll cover 3 disposed so that it can open and close in the front center part of a printer case 2 that covers a printer frame. An ink cartridge loading opening 8 is disposed on the left side of the paper roll cover 3, and an ink cartridge 4 can be inserted from this ink cartridge loading opening 8 and stored inside the printer. A power switch 5, feed switch 6, and indicators 7 are also disposed at the front of the printer case 2.

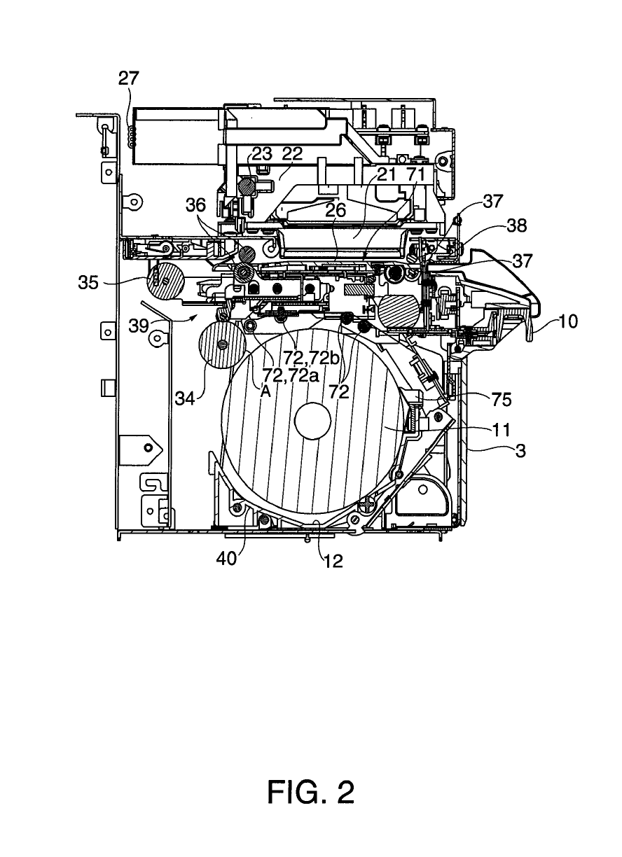

As shown in FIG. 2, the paper roll 11 used as the print medium is stored in a paper roll compartment 12. When the paper roll cover 3 is opened, the paper roll compartment 12 is open and the paper roll 11 can be loaded or replaced.

The paper roll cover 3 can pivot on its bottom end. A paper exit 9 from which the paper web is discharged after printing is positioned at the top of the paper roll cover 3, and an opening/closing slider 10 that can slide to the front is disposed below the paper exit 9.

When the slider 10 is pulled forward (to the front), a lock that holds the paper roll cover 3 in the closed position is released. When the slider 10 is then pulled further forward from this position, the paper roll cover 3 pivots on its bottom end and opens, thereby exposing the paper roll compartment 12 positioned behind the paper roll cover 3 so that a paper roll 11 can be dropped into the paper roll compartment 12.

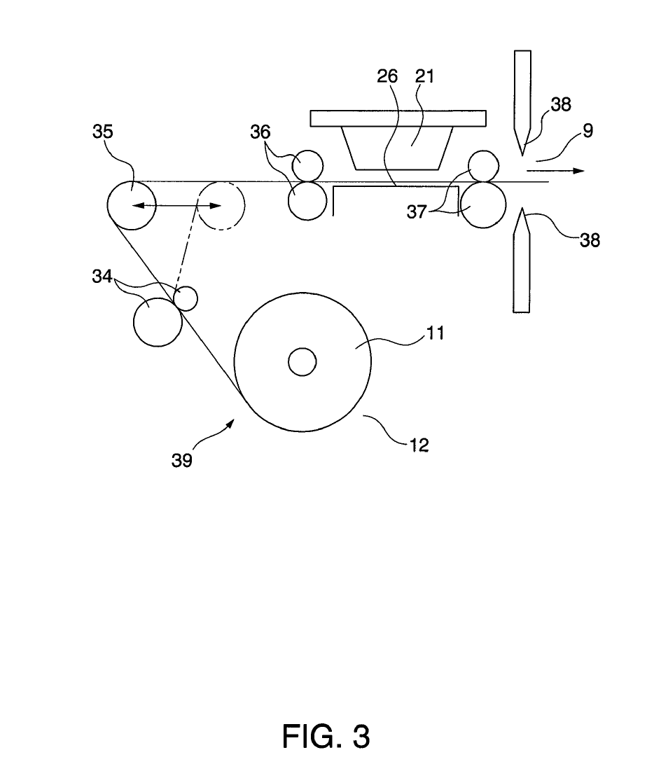

As shown in FIG. 3, supply rollers 34 for supplying the paper web from the paper roll 11 stored in the paper roll compartment 12 are disposed at the back top part of the paper roll compartment 12. The paper roll 11 is pulled away from the bottom 41 as a paper web is pulled from the paper roll 11 in the paper roll compartment 12 via supply rollers 34.

Main feed rollers (transportation rollers) 36 that hold and convey the paper web therebetween are disposed on the downstream side of the supply rollers 34. A tension roller 35 that is urged to the back side of the printer by an urging member (not shown in the figure) is also disposed on the transportation path between the supply rollers 34 and main feed rollers 36 to maintain a constant tension of the paper web on the main feed rollers 36.

Front feed rollers 37 that hold and convey the paper web therebetween are disposed downstream from the main feed rollers 36, and a platen 26 is disposed between the main feed rollers 36 and front feed rollers 37. A cutter 38 for cutting the printed paper web is disposed at the paper exit 9.

The paper web is pulled from the paper roll 11 in the paper roll compartment 12, conveyed passed the supply rollers 34, tension roller 35, main feed rollers 36, platen 26, and front feed rollers 37, and discharged from the paper exit 9. These transportation rollers 34, 36, 37 are driven by a supply motor or paper feed motor through an intervening transmission mechanism using gears or belts and pulleys, for example.

The supply rollers 34 unwind paper from the paper roll 11 stored in the paper roll compartment 12 in the form of a paper web and produce paper feed power. Rotation of the main feed rollers 36 is controlled with high precision so that the main feed rollers 36 convey the paper web at a precise paper feed pitch. The tension roller 35 stabilizes the paper feed precision by maintaining a constant load on the main feed rollers 36, and enables high speed paper feed by maintaining a constant amount of slack in the paper web fed from the paper roll 11.

The front feed rollers 37 are a pair of cylindrical rollers, and feed the paper web to the paper exit 9 while holding the paper web therebetween with a sufficient clamping force. If the paper web discharged from the paper exit 9 is pulled in a direction crosswise to the discharge direction (paper feed direction), the clamping force of the front feed rollers 37 prevents the paper from being lifted away from the platen 26, prevents paper jams resulting from the paper lifting off the platen, and thereby enables printing to continue normally with good results.

As shown in FIG. 2, the supply rollers 34 disposed at the back top part of the paper roll compartment 12 are positioned so that the paper transportation position A from which paper from the paper roll 11 stored in the paper roll compartment 12 is supplied is located vertically overlapping paper roll 11 of the maximum diameter that can be stored in the paper roll compartment 12. In some embodiments, the paper transportation position A is the first point where the supply rollers 34 contacts the paper supplied from the paper roll 11.

In some embodiments of the invention, the paper transportation position A is a position where the curve of the supply rollers 34 on the side contacting the paper roll 11 contacts a vertical line.

The tension roller 35, main feed rollers 36, and front feed rollers 37 are disposed to a platen unit 71 that includes the platen 26. The platen unit 71 is disposed above the paper roll compartment 12, and a plurality of guard pins (top movement limiting members) 72 are disposed on the paper roll compartment 12 side of the platen unit 71. The distance between the two guard pins 72a and 72b on the supply roller 34 side of these guard pins 72 is less than the smallest diameter of the paper roll 11.

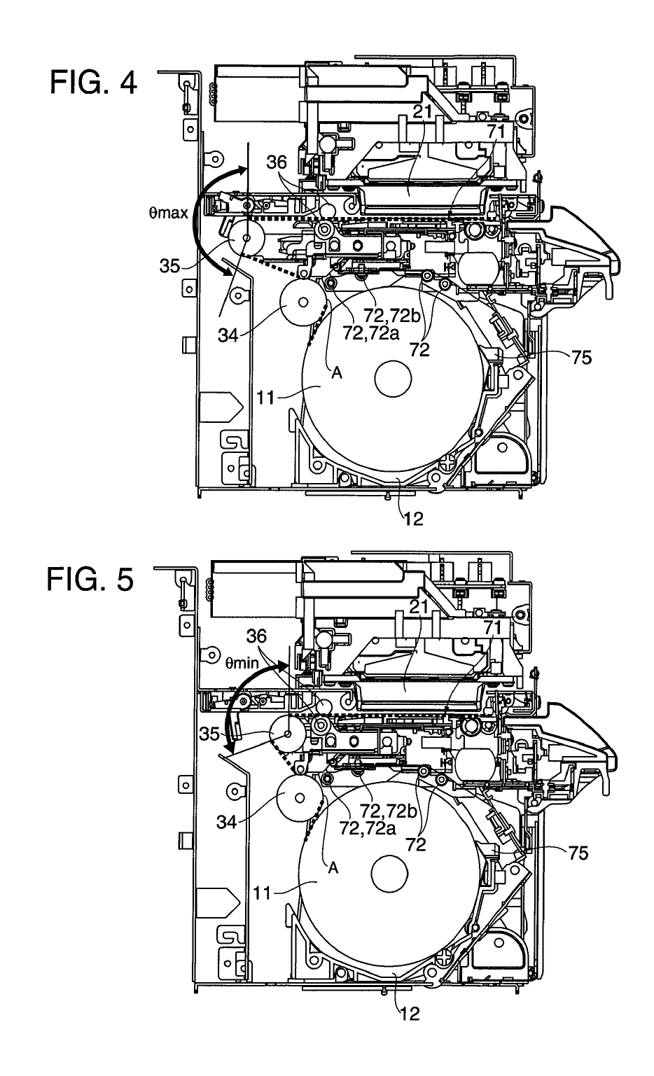

The tension roller 35 (e.g., a dancing roller) disposed to the platen unit 71 is supported so that it can move horizontally toward the platen unit 71, and is urged by a spring or other urging member (not shown in the figure) toward the back of the inkjet printer 1 (upstream in the transportation direction). The paper transportation path between the tension roller 35 and main feed rollers 36 is horizontal. If the contact angle of the tension roller 35, which is the central angle of the arc of the part that contacts the paper web, is θ, then the contact angle θ of the tension roller 35 at the maximum protrusion position of the tension roller 35 from the platen unit 71 as shown in FIG. 4 is the maximum contact angle θmax. As shown in FIG. 5, the contact angle θ of the tension roller 35 at the minimum protrusion position of the tension roller 35 from the platen unit 71 is the minimum contact angle θmin.

In the inkjet printer 1 according to some embodiments of the invention, the contact angle θ of the tension roller 35 is always greater than or equal to 90°. More specifically, whether the tension roller 35 is positioned at the maximum contact angle θmax shown in FIG. 4 or the minimum contact angle θmin shown in FIG. 5 or any position in between, a contact angle θ of 90° or more is always maintained.

As shown in FIG. 2, a carriage 22 on which an inkjet head 21 (printhead) is mounted is disposed inside the printer above the paper roll compartment 12. The inkjet head 21 is mounted on the carriage 22 so that the nozzles that discharge ink face the platen 26. The carriage 22 is supported freely movably widthwise to the paper on a guide member 23 that extends widthwise to the paper web, and is connected to an endless belt (not shown in the figure). A carriage motor (not shown in the figure) that drives this endless belt causes the carriage 22 to travel bidirectionally widthwise relative to the paper web above the platen 26.

A flexible ink tube 27 that forms at least part of the ink path that communicates with the ink cartridge is connected to the carriage 22. Ink is supplied through this ink tube 27 from the ink cartridge 4 stored in the ink cartridge storage unit to the inkjet head 21 carried on the carriage 22.

The standby position (home position) of the bidirectionally moving carriage 22 is on one side of the inkjet printer 1. An ink suction mechanism (not shown in the figure) that sucks ink from the nozzles of the inkjet head 21 is positioned below the carriage 22 in this standby position.

The inkjet printer 1 thus prints by discharging ink from the inkjet head 21 mounted on the bidirectionally travelling carriage 22 onto the portion of the paper web delivered from the paper roll 11.

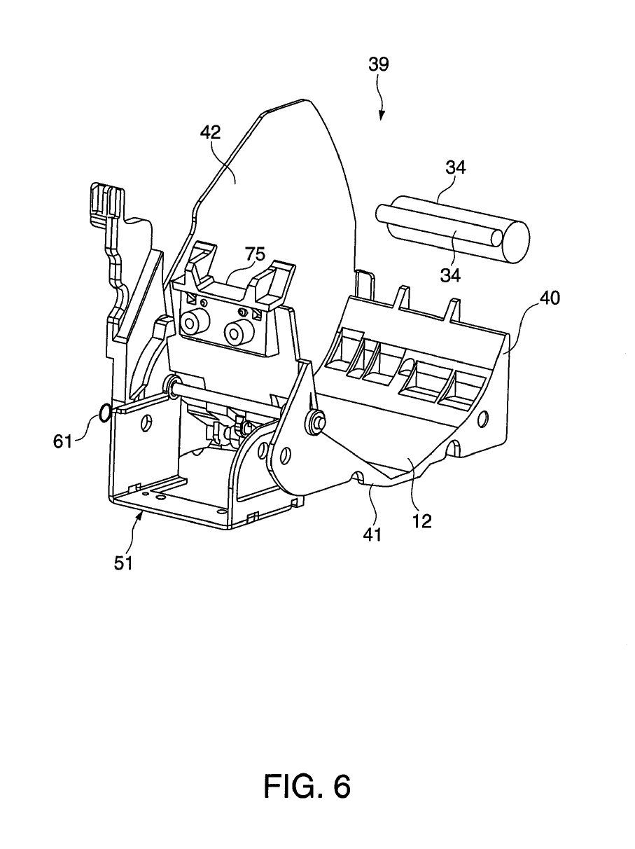

As shown in FIG. 2 and FIG. 6, a paper supply device 39 includes the paper roll compartment 12 and supply rollers 34. The paper roll compartment 12 includes a paper roll holder 40, and the paper roll holder 40 has a plastic bottom 41 that is curved when seen from the side, and a metal side pressure plate 42 (first side plate) that is connected to one side of the bottom 41. The paper roll 11 is placed on the bottom 41, and is stored in the paper roll compartment 12 so that it can roll with its axis of rotation extending transversely, that is, parallel to the rotational axis of the supply rollers 34.

The paper roll compartment 12 has a movement limiting member 75. The movement limiting member 75 is disposed to the paper roll holder 40 at a position (on the front side) on the side opposite to the side from which paper is pulled from the paper roll 11 by the supply rollers 34.

Movement of the paper roll 11 both horizontally and upwardly of the paper roll compartment 12 is limited by this movement limiting member 75. The paper roll 11 rolls when the paper is pulled therefrom by the supply rollers 34 and tends to move horizontally (forward in this specifically illustrated embodiment of the invention) as a result of this rolling, and the movement limiting member 75 limits this movement.

Note that the movement limiting member 75 can limit movement of the paper roll 11 both forward and upward as the diameter of the paper roll 11 decreases from the maximum diameter to the diameter at which the paper roll 11 touches the vertical line substantially passing through the paper transportation position A while resting on the bottom 41 of the paper roll compartment 12.

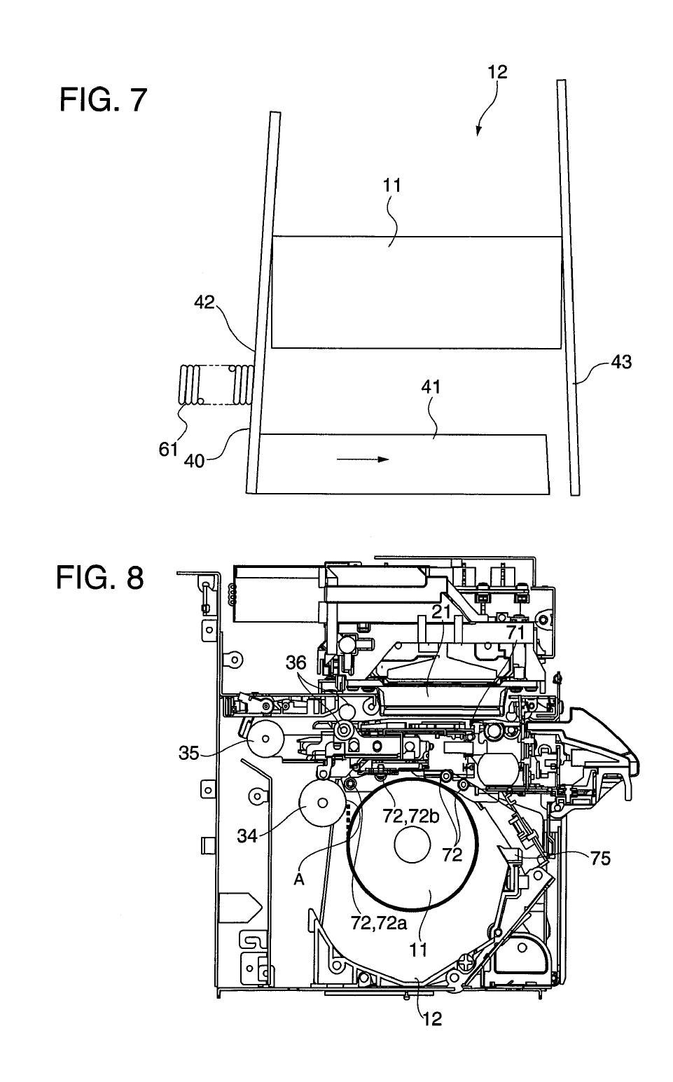

As shown in FIG. 6 and FIG. 7, the paper roll compartment 12 also has a metal side pressure plate 43 (second side plate) that is attached to the inside of the right side frame (not shown in the figure) of the inkjet printer 1 in opposition to the side pressure plate 42 of the paper roll holder 40. As a result, the paper roll 11 resting on the bottom 41 is disposed between side pressure plate 42 and side pressure plate 43 with one end of the paper roll 11 covered by side pressure plate 42 and the other end of the paper roll 11 covered by side pressure plate 43. Both side pressure plate 42 and side pressure plate 43 are touching the ends (side ends) of the paper roll 11.

As shown in FIG. 7, the side pressure plates 42 and 43 are inclined to the side ends of the paper roll 11 stored in the paper roll compartment 12. More specifically, the side pressure plates 42 and 43 are inclined so that they become closer to the side ends of the roll paper 11 with decreasing proximity to the supply rollers 34 that are disposed in the paper roll compartment 12 at the back top part of the inkjet printer 1. In other words, side pressure plate 42 and side pressure plate 43 converge toward each other so that the gap between side pressure plate 42 and side pressure plate 43 narrows in the direction in which paper is pulled from the paper roll 11. More specifically, the side pressure plate 42 and side pressure plate 43 are disposed so that the gap therebetween on the downstream side becomes narrower than the gap on the upstream side with respect to both the horizontal component and the vertical component of the direction in which paper is delivered from the paper roll 11. Note that the slope of the side pressure plates 42 and 43 is greater than or equal to the dimensional tolerance and deflection. In some embodiments, only one of the side pressure plates 42 and 43 is inclined whereas the other side pressure plate is vertical.

Note that the side pressure plate 42 (of the paper roll holder 40) is urged by a spring 61 to the other side pressure plate 43 side, and is positioned in contact with the frame 51 fixed to the bottom of the inkjet printer 1.

A paper supplying operation in conjunction with a printing process is described next.

When a printing process is run and a paper web is supplied by the supply rollers 34 by pulling paper from the paper roll 11 which rolls inside the paper roll compartment 12.

At this time the paper roll 11 is pressed from both sides by the side pressure plates 42 and 43, and its movement horizontally (forward) and toward the top of the inkjet printer 1 is limited by the movement limiting member 75. As a result, the paper roll 11 is held without bouncing around inside the paper roll compartment 12, and rotates smoothly.

As the diameter of the paper roll 11 decreases in conjunction with the printing process, the paper roll 11 is pulled toward the supply rollers 34 by the tension of the paper web being pulled by the supply rollers 34 as shown in FIG. 8. Because the side pressure plates 42 and 43 are inclined so that they approach the sides of the paper roll 11 with decreasing proximity to the supply rollers 34 at this time, the paper roll 11 contacts the side pressure plates 42 and 43 on both side ends thereof as it is pulled toward the supply roller 34. As a result, the paper roll 11 moves upward toward the supply rollers 34 along a vertical line passing through the paper transportation position A, and is held in a stable position in a top part of the paper roll compartment 12 without bouncing around.

Upward movement of the paper roll 11 is restricted by the guard pins 72 at this time, and the paper roll 11 is supplied without interfering with the mechanical parts of the platen unit 71. Note that two guard pins 72 positioned on the front side (the paper roll cover 3 side) can also limit horizontal movement of the paper roll 11 (toward the front).

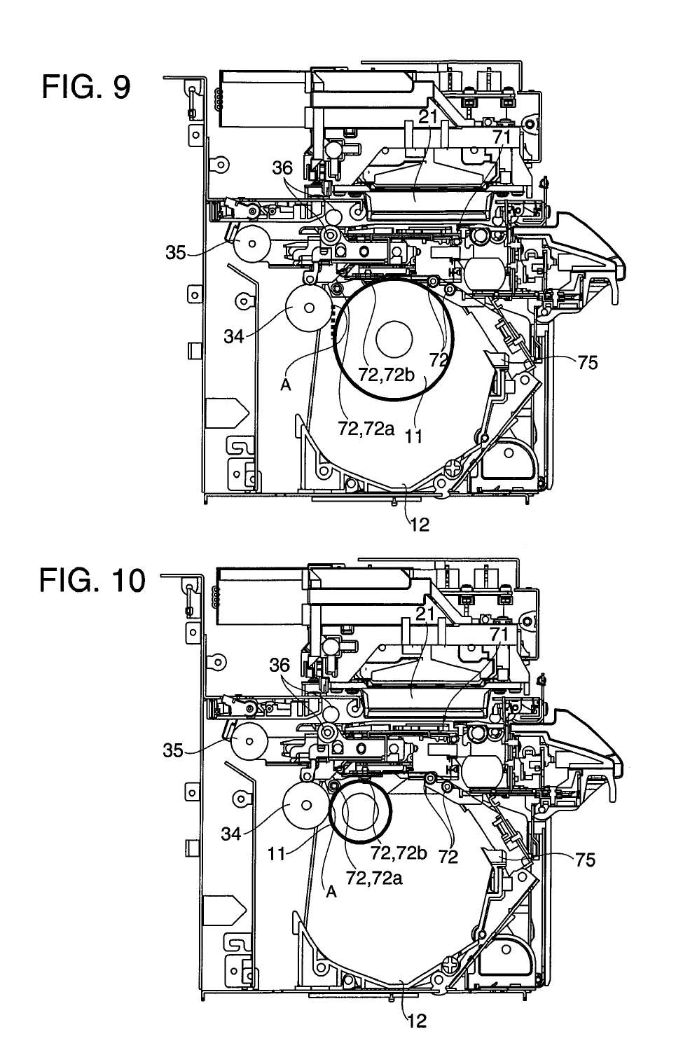

As shown in FIG. 9, the paper roll 11 is thereafter held at the top near the supply rollers 34 with its upward movement limited by the guard pins 72.

When the diameter of the paper roll 11 decreases further, the paper roll 11 is held stably at a top position even closer to the supply rollers 34 as shown in FIG. 10. As the paper roll 11 diameter becomes even smaller, the paper roll 11 contacts the guard pins 72a and 72b close to the supply rollers 34, and are held stably beside the supply rollers 34.

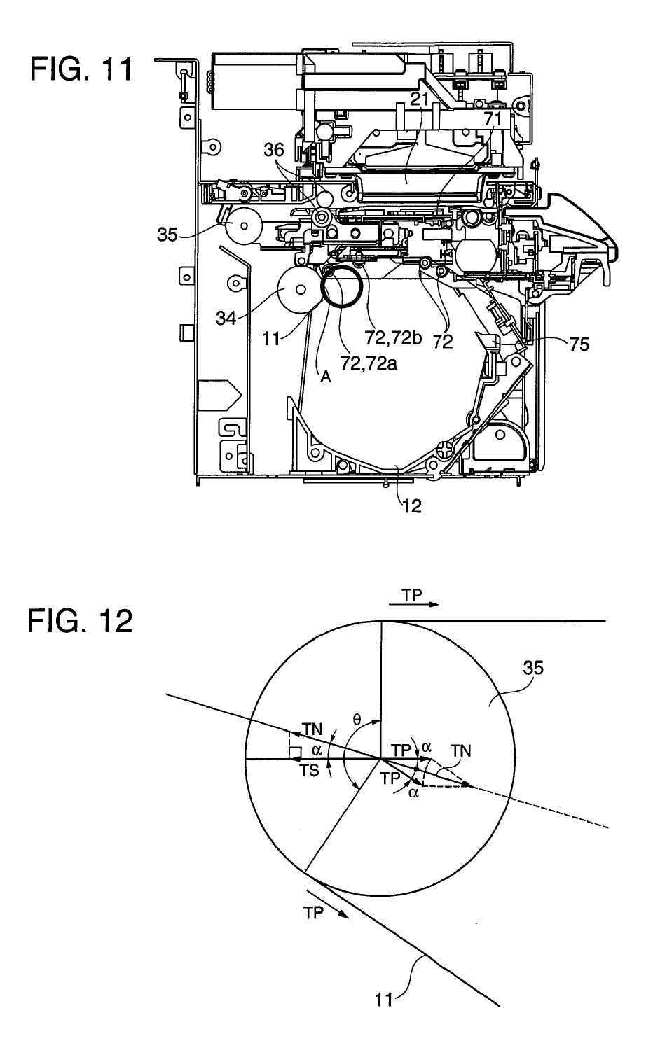

As shown in FIG. 11, even when the paper roll 11 decreases to the smallest diameter, further movement upward is limited by the guard pins 72 and the paper roll 11 is held at the top close to the supply rollers 34. Because the gap between the guard pins 72a and 72b close to the supply rollers 34 is smaller than the minimum diameter of the paper roll 11, the paper roll 11 is prevented from entering between the guard pins 72a and 72b.

As described above, a paper roll 11 of any diameter, that can be fit inside the paper roll compartment 12 to supply paper conveyed by the supply rollers 34, can be held desirably in the paper roll compartment 12 without bouncing around, and noise created by the paper roll 11 bouncing can be prevented or reduced in the inkjet printer 1 by one or more of the side pressure plates 42 and 43, movement limiting member 75, and guard pins 72. In addition, because the paper transportation position A of the supply rollers 34 is positioned vertically overlapping a paper roll 11 of the maximum diameter storable in the paper roll compartment 12, the inkjet printer 1 can be configured compactly in the front-back dimension.

More specifically, embodiments of the invention can consistently and stably supply a paper web from the paper roll 11 at a high paper feed rate, improve paper feed pitch precision, prevent the paper from lifting off the platen, assure excellent resistance to paper jams, and print with high quality without increasing the device size.

More particularly, upward movement of the paper roll 11 can be limited by the guard pins 72, and problems caused by interference of the paper roll 11 with mechanical parts of the platen unit 71 located thereabove can be eliminated.

FIG. 12 schematically describes the tension roller 35. As shown in FIG. 12, when the paper web is in contact with the tension roller 35 at contact angle θ, the paper web tension is TP, the urging force of the urging member in the direction away from the platen unit 71 is TS, the resultant tension is TN, and the angle of the vectors of the urging force TS and the tension TP is α, the following equations (1), (2) and (3) can be derived

$$\begin{matrix}α = \frac{{180}^{°} - θ}{2} & ( 1 ) \\ TN = \frac{TS}{cos α} & ( 2 ) \\ TP = \frac{\frac{TN}{2}}{cos α} = \frac{TS}{2 {( cos α )}^{2}} & ( 3 )\end{matrix}$$

From equations (1), (2), and (3), the relationship shown in equation (4) can be derived between the tension TP of the paper web and the urging force TS acting on the tension roller 35.

$$TP = \frac{TS}{2 {( cos \frac{{180}^{°} - θ}{2} )}^{2}} \qquad ( 4 )$$

If a coefficient k is defined as

$$TP = \frac{TS}{2 {( cos \frac{{180}^{°} - θ}{2} )}^{2}} ,$$

equation (4) can be restated as equation (5).

TP=kTS (5)

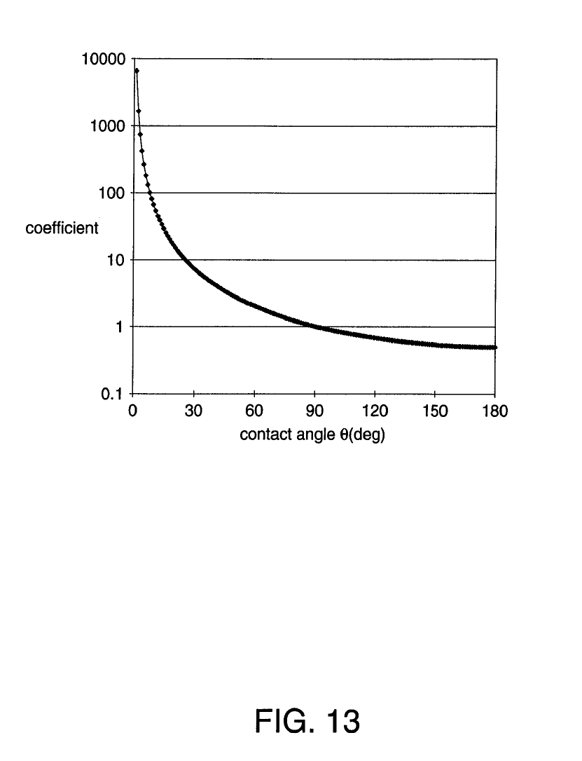

FIG. 13 is a graph of coefficient k. As shown in FIG. 13, coefficient k is less than or equal to 1 when the contact angle θ of the tension roller 35 to the paper web is greater than or equal to 90°, in which case the tension TP applied to the paper web is less than or equal to urging force TS as known from equation 5. Therefore, if the contact angle θ is 90° or greater, the tension TP applied to the paper roll 11 can be managed and set easily and desirably by adjusting the urging force TS applied to the tension roller 35.

However, the coefficient k is greater than or equal to 1 when the contact angle θ of the tension roller 35 to the paper web is less than 90°, and becomes large as the contact angle θ decreases. In this case the tension TP applied to the paper web is greater than the urging force TS as shown by equation 5, and increases as the contact angle θ decreases. Managing and setting the tension TP applied to the paper web by adjusting the urging force TS applied to the tension roller 35 therefore becomes difficult when the contact angle θ is less than 90°.

As described above, embodiments of the invention enable easily and desirably managing and setting the tension TP applied to the paper web pulled from the paper roll 11 by adjusting the urging force TS applied to the tension roller 35 when the contact angle θ to the paper web is 90° or greater. As a result, compared with configurations that stabilize paper tension by increasing the stroke of the tension roller 35, for example, embodiments of the invention enable appropriately applying constant tension to the paper pulled from the paper roll 11, consistently supplying paper smoothly and stably at a high paper feed rate, improving paper feed pitch precision, preventing the paper from lifting off the platen, achieving excellent resistance to paper jams, and printing with high quality without incurring increased device size.

More specifically, because the direction in which the tension roller 35 is moveable relative to the platen unit 71 is horizontal, and the transportation path between the tension roller 35 and main feed rollers 36 is horizontal, the stability of paper conveyance supplied to the main feed rollers 36 can be improved.

The print medium in some embodiments is not specifically limited to paper, but also includes film, cloth, and metal foil, for example.

The inkjet printer according to some embodiments may also be provided with some functions or mechanisms of a computer, a CRT or other display device, input devices, a floppy disk drive, or an optical drive, for example. For example, the printer may be configured with an image processing unit for image processing, a display unit for displaying information, and a recording medium drive for using recording media storing image data captured by digital cameras, for example.

A computer system including the printer according to some embodiments of the invention, a computer, a CRT or other display unit, a mouse, keyboard, or other input device, a floppy disk drive, or an optical drive will also be contemplated.

A color inkjet printer is used as the printer in the foregoing specifically disclosed embodiments, but other embodiments of the invention are not so limited and can be applied to any printing device that can print on a roll of printing medium, including monochrome inkjet printers, laser printers, thermal printers, and facsimile machines.

A printer according to some embodiments of the invention enables constantly stable supply of paper (or any other printing medium) from a roll in a sheet or web form, as well as high quality print without increasing the device size.

In some embodiments, the paper roll is held, as paper is delivered from the paper roll compartment by the supply roller (s), by means of the side pressure plates and/or one or more movement limiting member, so that the paper roll does not bounce around inside the paper roll compartment, thereby preventing or reducing noises resulting from the paper roll bouncing.

In some embodiments, the paper roll printer can be configured compactly, because the paper transportation position of the supply roller is on a vertical line through the largest diameter of a paper roll that can be stored in the paper roll compartment.

As a result, one or more embodiments of the invention can consistently and stably supply paper (or any other printing medium) at a high paper feed rate, improve paper feed pitch precision, prevent the paper from lifting off the platen, assure excellent resistance to paper jams, and print with high quality without increasing the device size.

In one or more embodiments where a top movement limiting member is provided, the paper roll is prevented from moving up due to the top movement limiting member, thereby preventing potential problems caused by interference of the paper roll with mechanical parts of the platen unit located above.

In one or more embodiments where the tension roller is disposed so that the minimum central angle of the arc of the part of the tension roller that contacts the paper roll is 90° or greater, the tension applied to the paper web can be managed and set very easily and desirably by adjusting the urging force applied to the tension roller. As a result, constant paper tension can be appropriately maintained, the paper web can be stably conveyed smoothly, and high print quality can be assured.

Although various embodiments of the present invention have been described in connection with specific details and with reference to the accompanying drawings, it is to be noted that various changes and modifications will be apparent to those skilled in the art and covered within the scope of the appended claims.

What is claimed is:

1. A paper roll printer, comprising:
a paper roll compartment for storing therein a paper roll with a transverse axis of rotation;
a supply roller for supplying a web of paper from the paper roll stored in the paper roll compartment;
side pressure plates that are inclined for touching side ends of the paper roll and become closer to the side ends with decreasing proximity to the supply roller;
a platen unit including transportation rollers that are disposed downstream of the supply roller in a transportation path and above the paper roll compartment for holding and conveying the web of paper along the transportation path; and
a tension roller that is moveably supported on the platen unit at a position on the transportation path between the supply roller and the transportation rollers to maintain constant paper tension on the transportation rollers; and
a movement limiting member disposed to the paper roll compartment at a position opposite the supply roller for limiting movements of the paper roll horizontally and upwardly in the paper roll compartment;
wherein a paper transportation position of the supply roller is disposed on a vertical line through a paper roll of the maximum diameter storable in the paper roll compartment.

2. The paper roll printer of claim 1, further comprising:
a top movement limiting member for limiting movements of the paper roll upwardly above the supply roller, and for preventing the paper roll from coming in contact with the platen unit.

3. The paper roll printer of claim 1, wherein:
the tension roller is disposed so that a minimum central angle of the arc of the part of the tension roller that contacts the paper supplied from the paper roll is 90° or greater.

4. The paper roll printer of claim 1, wherein:
the paper roll compartment includes
a bottom on which the paper roll is positionable,
a first side plate for facing and contacting one of the side ends of the paper roll positioned on the bottom, and
a second side plate for facing and contacting the other side end of the paper roll positioned on the bottom, and
the first side plate and second side plate define said side pressure plates, respectively, and are disposed so that the gap between the first side plate and second side plate across the width of the paper roll narrows in the direction in which paper is pulled from the paper roll.

5. A paper roll printer, comprising:
a printhead;
a platen unit having a platen opposite the printhead;
a paper roll compartment for storing a paper roll;
a supply roller for supplying a paper web from the paper roll stored in the paper roll compartment;
a transportation roller for conveying the paper web and disposed downstream of the supply roller in a transportation path and upstream of the printhead in the transportation path; and
a tension roller for contacting the paper web being conveyed between the supply roller and the transportation roller;
wherein the paper roll compartment includes
a bottom on which the paper roll is positionable,
a first side plate for facing and contacting one of opposite side ends of the paper roll positioned on the bottom,
a second side plate for facing and contacting the other side end of the paper roll positioned on the bottom, and
a movement limiting member for limiting movements of the paper roll horizontally and upwardly, and positioned opposite the supply roller,
wherein the first side plate and the second side plate are disposed so that the gap between the first side plate and second side plate across the width of the paper roll narrows in the direction in which the paper web is pulled from the paper roll;
the supply roller is disposed so that, when a paper roll of the maximum storable diameter is stored in the paper roll compartment, the contact point of the supply roller with the paper web vertically overlaps the paper roll of the maximum diameter; and
the platen unit is positioned above the paper roll compartment and includes the transportation roller and the tension roller, and the tension roller is supported movably horizontally on the platen unit and is urged in a direction away from the printhead.

6. The paper roll printer of claim 5, wherein:
when the paper web is pulled upward from the bottom by the supply roller, the first side plate and the second side plate are adapted to contact the side ends of the paper roll and hold the paper roll at the side where the gap between the first side plate and the second side plate is narrow.

7. The paper roll printer of claim 5, wherein:
the transportation path is horizontal between the tension roller and the transportation roller.

8. A printer, comprising:
a compartment for storing therein a roll of a printing medium with a transverse axis of rotation;
a supply roller for pulling a web of the printing medium from the roll stored in the compartment; and
side pressure plates for facing and touching opposite side ends of the roll, respectively;
wherein said side pressure plates converge toward each other so that the gap between said side pressure plates narrows in the direction in which the printing medium is pulled from the roll.

9. The printer of claim 8, wherein
one of the side pressure plates is urged toward the other side pressure plate.

10. The printer of claim 8, further comprising:
a spring urging one of the side pressure plates toward the other side pressure plate.

11. The printer of claim 8, wherein
a contact point where the web first contacts supply roller vertically overlaps a roll of the maximum diameter storable in the compartment.

12. The printer of claim 8, further comprising:
a tension roller positioned downstream of the supply roller on a transportation path along which the web is to be conveyed;
wherein said tension roller is moveable along said transportation path for maintaining a constant tension in the web to be conveyed.

13. The printer of claim 12, wherein
the tension roller is disposed so that a minimum central angle of the arc of the part of the tension roller that contacts the web supplied from the roll is 90° or greater.

14. The printer of claim 12, further comprising:
a platen unit including transportation rollers that are disposed downstream of said tension roller on the transportation path for holding and conveying the web along the transportation path;
wherein said tension roller is moveably supported by the platen unit.

15. The printer of claim 14, further comprising:
a printhead;
wherein the platen unit further includes a platen opposite the printhead and is positioned above the compartment.

16. The printer of claim 15, wherein
the tension roller is urged away from the printhead.

17. The printer of claim 8, further comprising:
a movement limiting member disposed in the compartment for limiting movements of the roll horizontally and upwardly in the compartment.

18. The printer of claim 17, wherein
the movement limiting member is disposed at a position opposite the supply roller.

19. The printer of claim 17, further comprising:
at least one top movement limiting member for limiting upward movements of the roll;
wherein said at least one top movement limiting member is positioned at the side to which said side pressure plates converge.

20. The printer of claim 19, wherein
said at least one top movement limiting member includes two top movement limiting members space from each other a distance less than a minimum diameter of the roll.
